(19) United States
(12) Patent Application Publication
(10) Pub. No.: US 2009/0320231 A1
(43) Pub. Date: Dec. 31, 2009

(54) STEAM MOP

(76) Inventors: Maximilian Rosenzweig, Montreal (CA); Ognjen Vrdoljak, Laval (CA); Eric Wall, Auburn, AL (US); Danny Xu, Milton, MA (US)

Correspondence Address: MCCARTER & ENGLISH, LLP STAMFORD, FINANCIAL CENTRE , SUITE 304A, 695 EAST MAIN STREET, STAMFORD, CT, 06901-2138, US

(21) Appl. No.: 12/163,537

(22) Filed: Jun. 27, 2008

(51) Int. Cl. B08B 3/00

(52) U.S. Cl. 15/339; 15/412

(57) ABSTRACT

A steam mop including a mop housing is provided. The mop housing includes a water tank with a water inlet and a water outlet, a water pump with a pump inlet and a pump outlet and a boiler. A mop handle is connected to the mop housing at one end and a steam frame is connected to the housing at the opposite end. The water tank has a water inlet opening to a surface of the housing with a removable inlet cap where the surface of the housing about the cap has a funnel shape. The water pump is coupled to the outlet of the water tank and inlet of the boiler so that movement of the steam mop activates the pump to pump water from the water container to the boiler for the generation of steam. In addition, a steam frame assembly provided with a fabric steam pocket is selectively removable from the housing. The frame has an opening about the middle of rear wall for mounting a connector including a top end having a steam inlet for connecting to a steam housing and a bottom end having a pair of steam nozzles for connecting to the steam frame and a plurality of baffles are disposed perpendicular to the pair of steam nozzles between the front and rear walls.

### BACKGROUND OF THE INVENTION

The invention relates generally to a fluid mop, and more particularly to a steam mop.

Wet and dry mops have been widely used for cleaning floors. A type of wet mop is a steam mop, which works as a steaming device. Steaming devices used to apply steam to household objects are well known. The uses of the devices vary widely, and may include the application of steam to drapes or other fabrics to remove wrinkles, and the application of steam to objects to assist in cleaning various objects.

Typical steam devices have a reservoir for storing water that is connected to an electrical water pump with an on/off switch. The electric water pump outlet is connected to a steam boiler with a heating element to heat the water. The heated water generates steam, which may be directed towards its intended destination through a nozzle which controls the application of the steam.

An indication to the user when the water supply has depleted in the reservoir of the steam device is preferred. For instance, there may be a safety device to sense if the water is below a minimum threshold which in turn either turns on an indication light or automatically turns off the boiler in the mop. Typically, this provides an indication to the user to replenish the water supply after the water supply in the reservoir has been depleted.

Variation of the shapes and sizes of nozzles allows for preferred distribution of generated steam to an object to be cleaned. The nozzles may be disconnectable from the steam generator to allow different nozzles to be utilized, based on the object to be steamed. The nozzle may be either closely coupled to the steam generator, or located at a distance from the steam generator, requiring tubing or other steam transfer structures to be interconnected between the steam generator and the discharge nozzle. Thus, a universal type of opening in the steam device is needed to connect to the various types of mop frames, nozzles and or tubing.

Accordingly, it is desirable to provide an improved steam mop to improve ease of use, such as a water reservoir that shows a current indication of what the water supply a mop housing that easily disconnects from a steam frame and has an improved steam pocket and frame.

### SUMMARY OF THE INVENTION

Generally speaking, in accordance with the invention, a steam mop having an improved mop housing containing a water tank with a water inlet having a funnel shaped entry to facilitate filing a reservoir in the mop housing is provided. The housing also includes at least one transparent window to the reservoir allowing a user to view the level of water in the reservoir. An LED in the tank provide improved visibility of the water lever in the tank. In a preferred embodiment the housing is easily disconnected from an adapter on the steam frame.

Accordingly, it is an object of the invention to provide an improved steam mop housing.

It is another object of the invention to provide a housing that has a water tank that includes a funnel shaped water inlet opening for ease of filling.

Another object of the invention is to provide a water tank that includes at least one window and a LED for an indication of the water level in the water container.

A further object of the invention is to provide improved steam frame for a steam mop.

Yet another object of the invention is to provide a steam mop housing with a bottom opening that easily connects and disconnects to a steam frame to provide a fluid source in the mop housing.

Yet a further objection of the invention is to provide a steam frame readily removable from the housing.

Still another object of the invention is to provide a steam mop housing with an easily operable release button for easy removal of the steam frame from the mop housing.

Still other objects and advantages of the invention will in part be obvious and will in part be apparent from the specification.

The invention accordingly comprises a product possessing the features, properties, and the relation of components which will be exemplified in the product hereinafter described, and the scope of the invention will be indicated in the claims.

### BRIEF DESCRIPTION OF THE DRAWINGS

For a fuller understanding of the invention, reference is made to the following description taken in connection with the accompanying drawing(s), in which:

FIG. 1 is a perspective view of a steam mop constructed and arranged in accordance with one embodiment of the invention;

FIGS. 2A and 2B are perspective side views of the mop housing in the steam mop of FIG. 1 showing the water inlet and funnel;

FIG. 3 is a front view of the mop housing in section showing a reservoir, a pump and a boiler of FIG. 1;

FIG. 4 is a front elevational view of the mop housing in section showing connections for reservoir, boiler and steam mop frame in accordance with one embodiment of the invention;

FIG. 5 is an elevation view in section of the pump and boiler of FIG. 5;

FIG. 6 is a plan view of a steam pocket frame for use with the steam mop of FIG. 1;

FIG. 7 is a front perspective view of a fabric steam pocket suitable for use with the steam frame of FIG. 6;

FIG. 8 is a plan view of a mop handle suitable for use with the steam mop of FIG. 1;

FIG. 9 is an exploded perspective view showing how the steam mop frame assembly is installed on mop housing of FIGS. 1-3 in accordance with one embodiment of the invention;

FIG. 10 is a perspective view of an upper connector piece of the connector in FIG. 9;

FIG. 11 is a perspective view of a fluid distributor of the connector of FIG. 10;

FIG. 12 is an elevational view in partial section of the fluid distributor of FIG. 11;

FIG. 13 is an exploded view in section showing how the connector attaches to the housing;

FIG. 14 is a section view of the frame connector engages by the latch of the housing;

FIG. 15 is a front perspective view of the housing in section showing how the latch engages the notch of frame connector; and

FIG. 16 is a top perspective view of arm of release button that engages stem of connector.

### DETAILED DESCRIPTION OF THE INVENTION

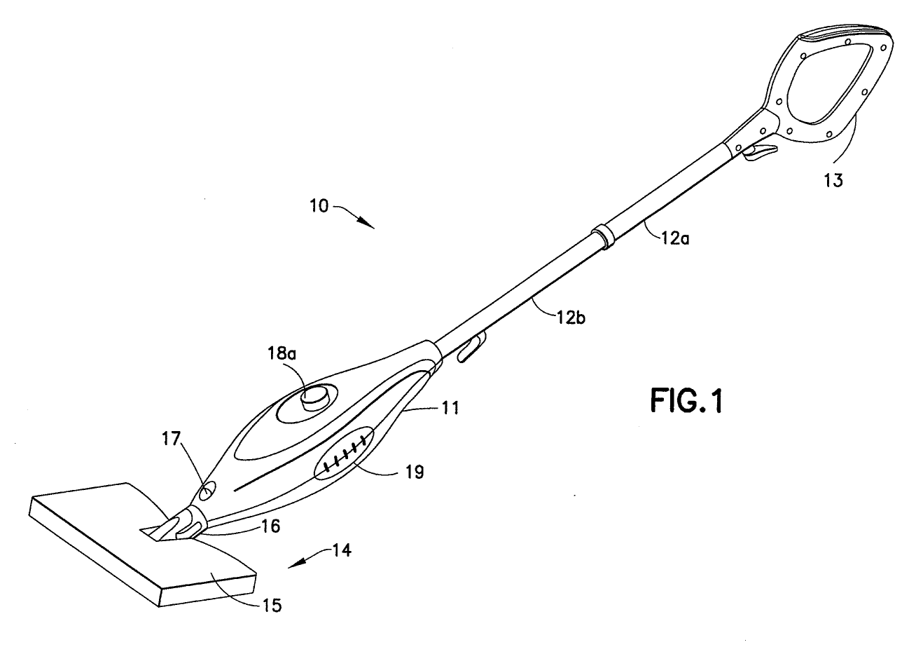

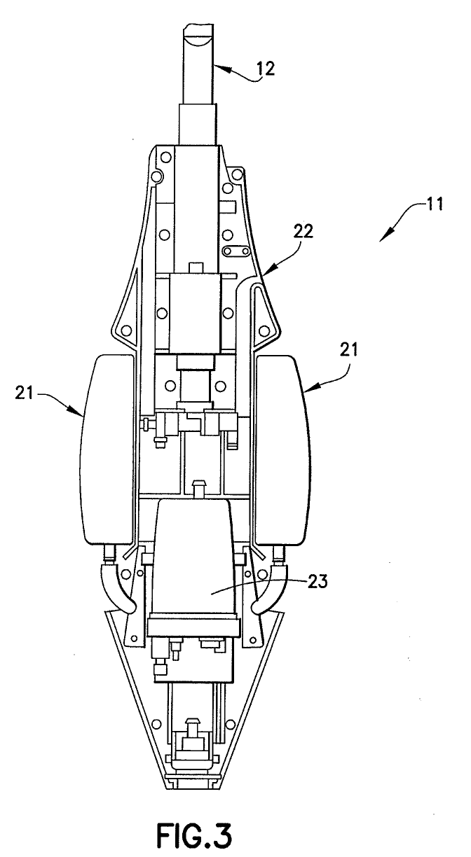

FIG. 1 is a perspective view of a steam mop 10 constructed and arranged in accordance with the invention. Mop 10 includes an elongated housing 11 with a water reservoir 21 and a boiler 23 and an upper tube 12a and a lower tube 12b connected to one end of housing 11. A handle 13 is attached to the end of upper tube 12a. A steam frame 14 with an installed steam pocket 15 is operatively connected to the other end of housing 11 by a connector 16. In this embodiment, connector 16 and frame 14 may be removed from housing 11 by pressing a release button 17 at the base of housing 11. Water is introduced into a reservoir 21 at a water inlet or opening 18a. The level of water present in a reservoir 21 in housing 11 shown in FIG. 3 can be viewed through a sighting window 19. The specifics of fabric steam pocket 15 will be described below.

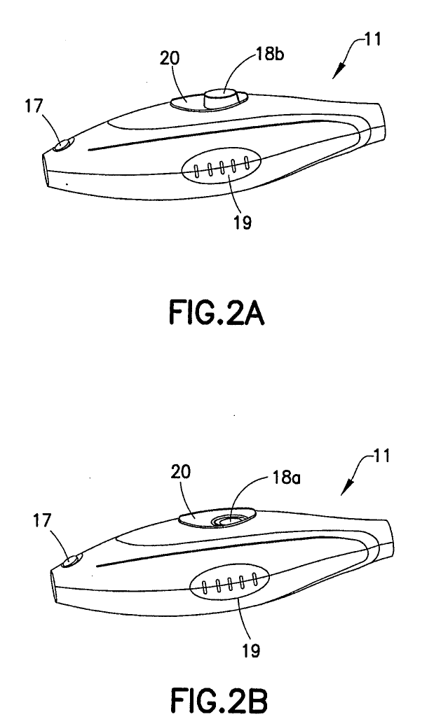

FIGS. 2A and 2B are perspective side views of housing 11. Water inlet 18a has a water cap 18b that is removed for filling to exposed opening 18a. The region around opening 18a is shaped like a funnel 20 allows a user to fill reservoir 21 without spilling. Housing 11 also includes at least one sighting window 19 that allows a user to observe the water level in water container 21.

FIG. 3 is a front plan view in section showing the location of elements in housing 11. Water container 21 is positioned adjacent and surrounds a boiler 23. A one-way pump 22 pumps water from reservoir 21 to boiler 23 in response to the push-pull movement of mop 10. This movement of handle 13 causes operation of one way valve 22 as will be described in detail below. Here, water container 21 wraps around the back of housing 11.

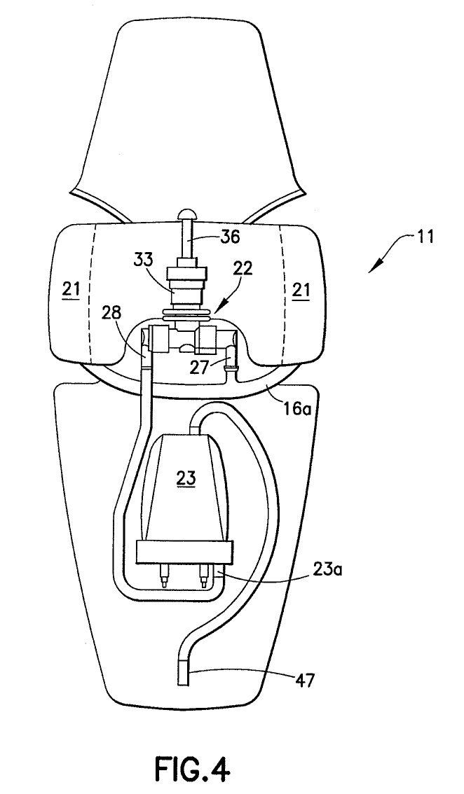

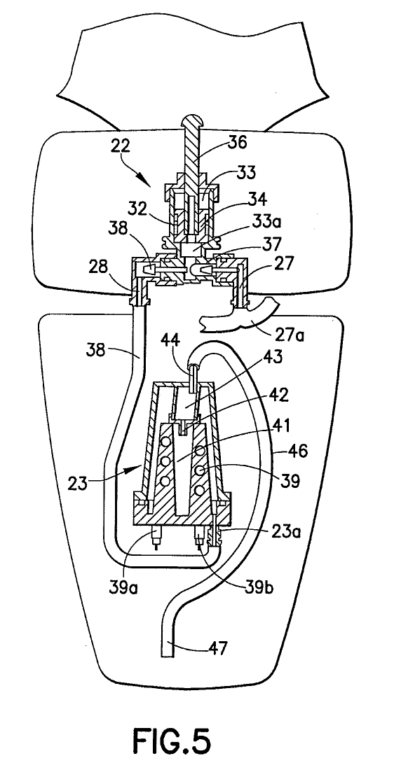

FIG. 4 is a detailed front view of showing how water container 21, showing the hoses connecting one-way pump 22 and boiler 23 as described in connection with FIG. 5. Water pump 22 includes a pump body 33 having a pump cavity 33a. A pump piston 34 is connected to a push rod 36 which in turn is connected to pole 12 or handle 13. As mop handle 13 is pulled by a user piston 34 creates a negative pressure in cavity 33a. This draws water from reservoir 21 into a water supply hose 21a that feeds into pump water inlet 27 through a one-way inlet valve 37 to fill cavity 33a. As handle 13 is pushed during use, piston 34 moves downward and water in cavity 33a is expelled through a one-way outlet valve 38 into pump outlet hose 28. This water is then introduced into a boiler inlet 23a in boiler 23. Water in boiler 23 is heated by a heating element 39 in a boiler cavity 41. Heating element 39 is connected to electrical connectors 39a and 39b. Steam generated in boiler cavity 41 is fed through a steam valve 42 into a steam chamber 43. Steam is then expelled through a steam outlet 44 to a steam hose 46 and to a steam outlet fitting 47.

One-way inlet valve 37 and one-way outlet valve 38 are duck-bill valves formed of a flexible elastomeric material, such a rubber. The valves are conical in shape so that when handle 13 is pulled, water is drawn through inlet valve 37 while outlet valve 38 remains closed. Similarly, when handle 13 is pushed, water is forced out through outlet valve 38 and inlet valve 37 remains closed and water is fed into boiler 23. In another embodiment, a mechanical bellow pump that may be used in steam mop housing 11 to pump water from water container 21 to boiler 23. Alternatively, the pump can be a two-way piston pump that pumps water when its piston is displaced both in the forward direction and also in the return backwards motion. This type of pump is shown in co-pending application Ser. No. 11/842,478. The contents of which are incorporated herein by reference in its entirety.

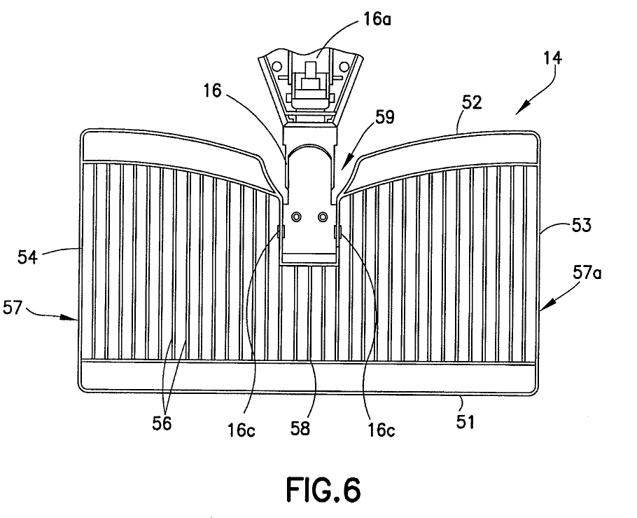

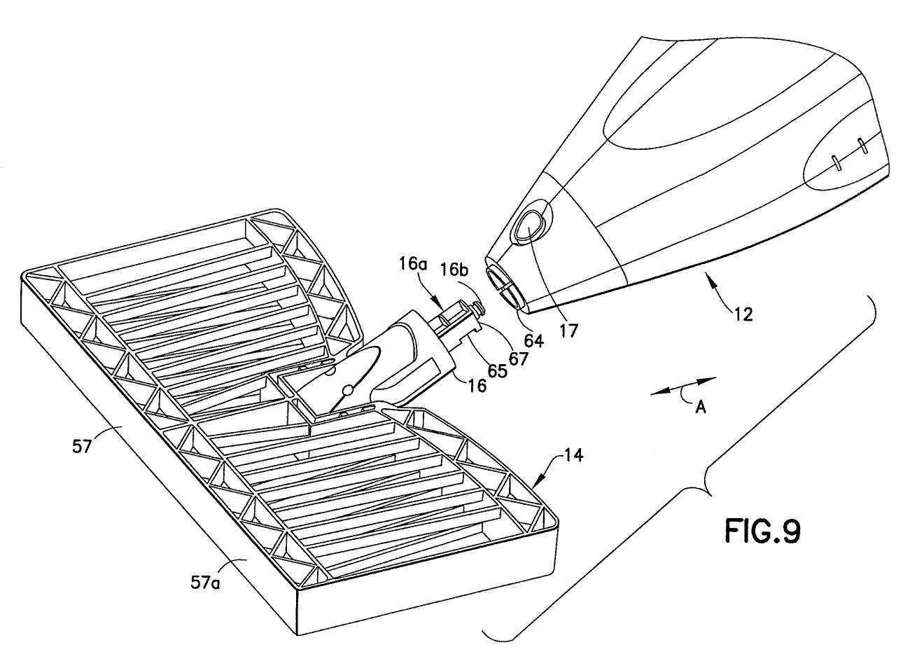

Referring now to FIGS. 6 and 9, the details of steam pocket frame 14 are shown. Steam pocket frame 14 is substantially rectangular and includes a front wall 51, a rear wall 52, a right side wall 53, and a left side wall 54. Front wall 51 and rear wall 52 provides additional firm surface area to help dry the floor. A pair of steam chambers 57 and 57a with a plurality of baffles or structural ribs 56 that are separated by a partition 58 that extends from the top of steam frame 14 to the bottom. This forms two separate steam chambers 57 and 57a. Here, baffles 56 are planar slats and extends from front wall 51 to rear wall 52 within frame 14. Baffles 56 provide structure to frame 14 but do not extend from top to bottom. Slats 56 alternate position on the top and bottom forming an upper surface and a lower surface for supporting fabric steam pocket 15.

In another embodiment, baffles 56 may extend diagonally from front wall 51 to rear wall 52 within frame 14. Rear wall 52 of frame 14 has an opening 59 that is substantially about the middle of rear wall 52 for mounting connector 16 to connect to steam generated in boiler 23. Connector 16 includes an upper stem end 16a with a steam inlet 16b (as shown in FIG. 9) for connecting to steam outlet fitting 47 in housing 11. The lower section of connector 16 includes bottom end having a pair of steam nozzles 16c for connecting to steam frame 14. Steam nozzle 16c on the right side of connector 16 provides steam to steam chamber 57a on the right. Steam nozzle 16c on the left side of connector 16 provides steam to steam chamber 57 on the left.

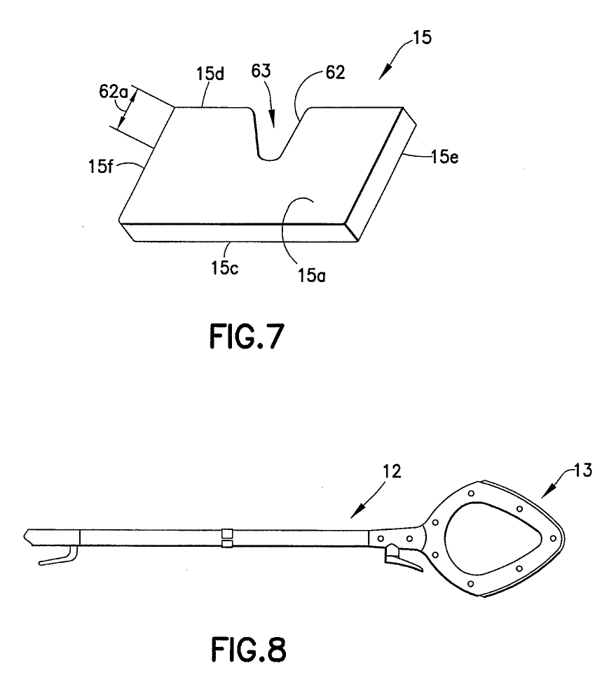

Referring now to FIGS. 1 and 7, fabric steam pocket 15 is configured to slip over frame 14 in accordance with one embodiment of the present invention. In this respect, pocket 15 is formed of a first layer of fabric 15a and an opposed second layer of fabric 15b (not shown). Fabric layers 15a and 15b each have a substantially rectangular shape with two opposed long edges 15c and 15d and two opposed short sides 15e and 15f. Long edge 15c and two opposed short side 15e and 15f are stitched to form pocket 15. Accordingly, fabric steam pocket 15 is open on long edge 15d. The fabric along the opening on long edge 15d may be optionally closed with a hook and loop fastener, buttons or snaps. Here, steam pocket 15 is cut along a line 62 to form a slot 63 around the width of connector 16 on the first layer 15a and opposed second layer 15b to fit around connector body 16. Slot 63 has a length a distance 62a from rear edge 15d to about the pair of nozzles 16c shown in FIG. 7. This allows for vertical rotation of housing 11 without bending the fabric of fabric steam pocket 15 and use of both sides of steam pocket 15 for cleaning without having to remove and re-install steam pocket 15.

In this illustrated embodiment, steam pocket 15 is a cloth or towel. Steam pocket may be formed of any suitable fabric such as cotton or a synthetic fabric, such as polyester or polyolefin fiber. Preferably, the fabric of pocket 15 is a microfiber. Most preferably, the microfiber is a synthetic polyester microfiber.

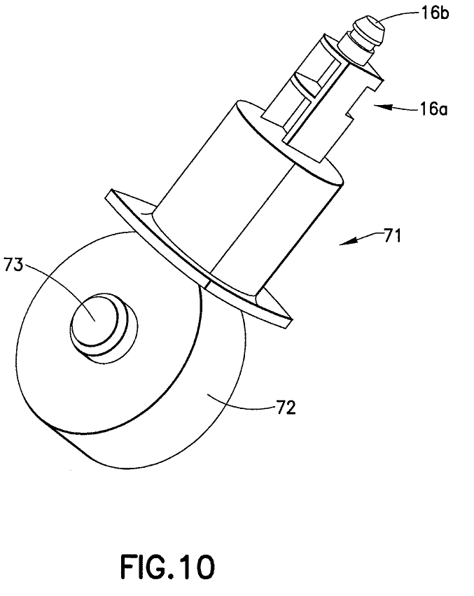

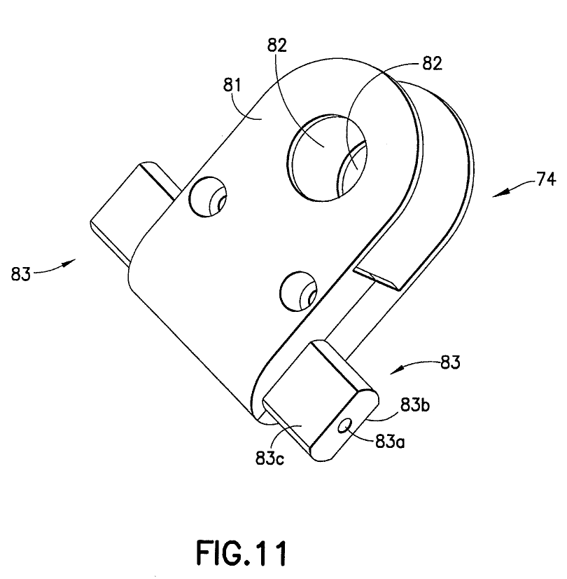

FIG. 10 shows an upper connector piece 71 of a universal connector as shown in co-pending application Ser. No. 12/118,015, the contents of which are incorporated herein by reference in its entirety. Upper piece 71 has a stem 16a with a steam inlet 16b for connection to steam outlet fitting 47 in housing 11 connector 71 includes a pair of inner pivot plates 72 with pivot buttons 73 at the lower end for pivotal connection to a fluid distributor 74 as shown in FIG. 11. Fluid distributor 74 includes a hollow nipple portion 76 and a pair of arms 83 that engages frame 14 as will be discussed in more detail below. To use this type of connector, frame 14 has a pair of receiving slots as shown in the co-pending application with a key hole piece for receiving and for engaging fluid distributor 74.

Referring now to FIG. 11, fluid distributor 74 includes two upwardly extending distributor plates 81 with holes 82 for aligning with pivot buttons 73 of upper connector inner pivot plates 72 to provide the right and left pivot connection between upper connector piece 71 and fluid distributor 74.

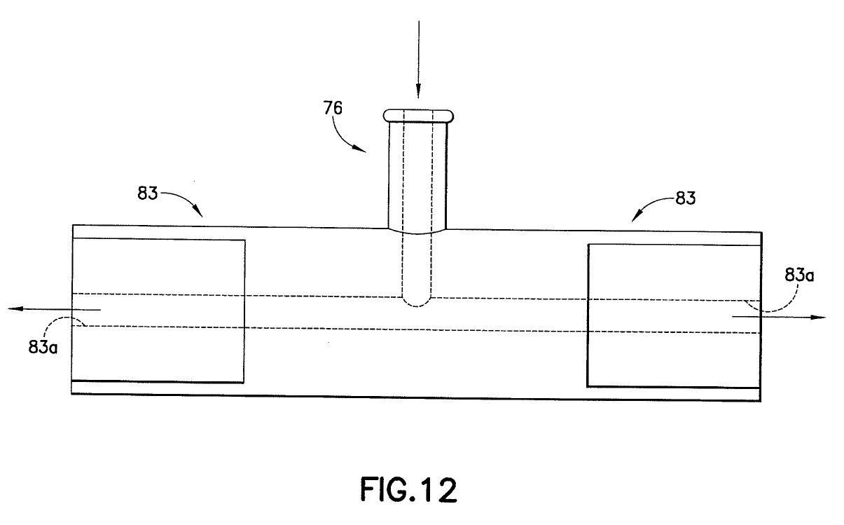

As shown in FIG. 12, fluid distributor 74 includes hollow nipple portion 76 for connecting to the fluid source. Hollow nipple portion 76 in turn connects to upper connector piece 71 and stem 16a is connected to the fluid source of housing 11. Pivot arms 83 that fit into receiving slots 78 of frame 14 for connecting connector 16 to mop frame 14 for pivoting up and down are also hollow. Each arm 83 includes a fluid opening 83a. Distributor arms 83 have two opposed flat surfaces 83b and 83c at their respective ends for coupling to frame 14. Fluid enters hollow nipple portion 76 and is transported through opening 83a to frame 14.

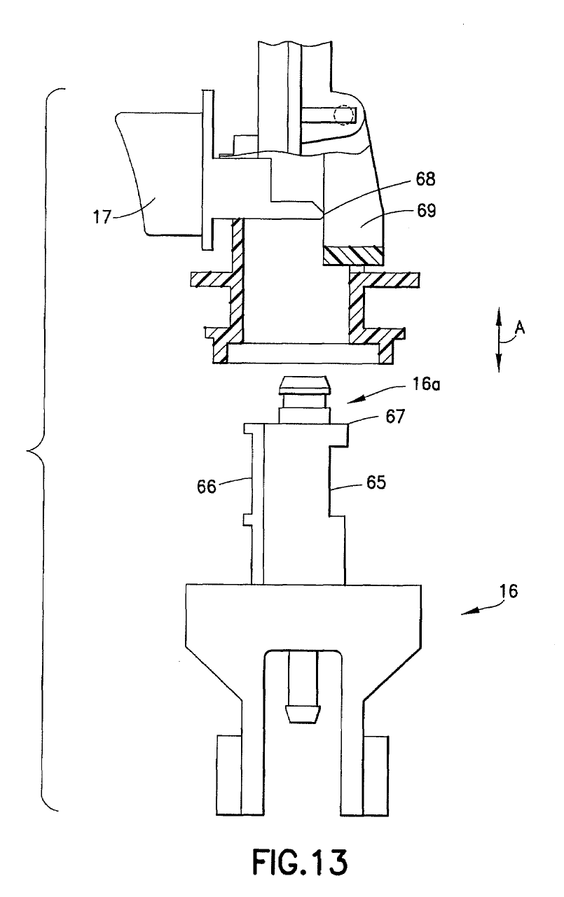

FIG. 13 is an exploded perspective view showing how steam frame 14 is installed on or removed from housing 11, by movement in a direction indicated by arrow A. Release button 17 may have an indentation or a rubberized surface to prevent slippage when user presses release button 17 to detach steam frame 14 from housing 11. Release button 17 may be a spring loaded or hinge type button so that on depressing button 17, stem 16a is released.

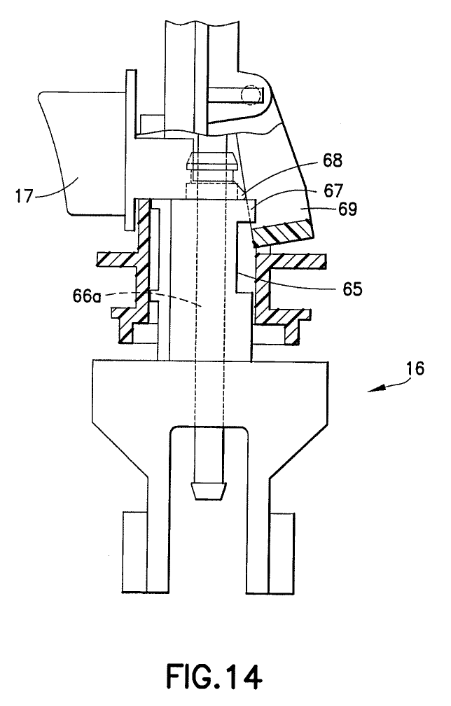

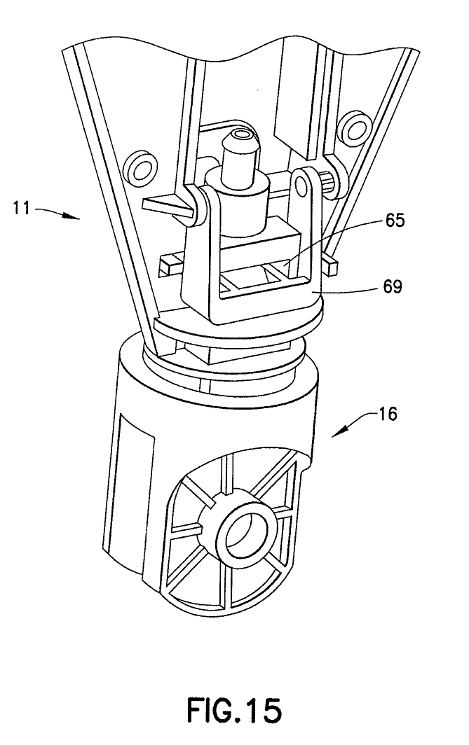

FIGS. 14 and 15 show how stem 16a of connector 16 is engaged within opening 64 in housing 11. Here, stem 16a is tubular shaped and opening 64 is also tubular shaped to insure that connector 16 is properly aligned when frame 14 is connected to housing 11. Release button 17 has an arm 68 with a u-shaped opening 68a that surrounds flange 67 on stem 16a when button 17 is biased outwardly. At this time a latch 69 fits within notch 65 and secures stem 16a within housing 11. When button 17 is depressed, arm 68 urges latch 69 to and disconnect from to a notch 65 on connector 16 defined by flange 67. Connector 16 is installed on housing 11 by inserting stem 16a into opening 64 of housing 11. U-shaped opening 68a on arm 68 that was aligned with the axis of opening 64 is displayed and then latch 69 engages notch 65 on connector 16. To detach connector 16 from housing 11, a user merely presses release button 17 so arm 68 moves u-shaped opening 68a to push latch 69 away from notch 65.

In another embodiment of the invention, stem 16a may be key shaped and opening 64 is also key shaped to insure that connector 16 is properly attached to housing 11.

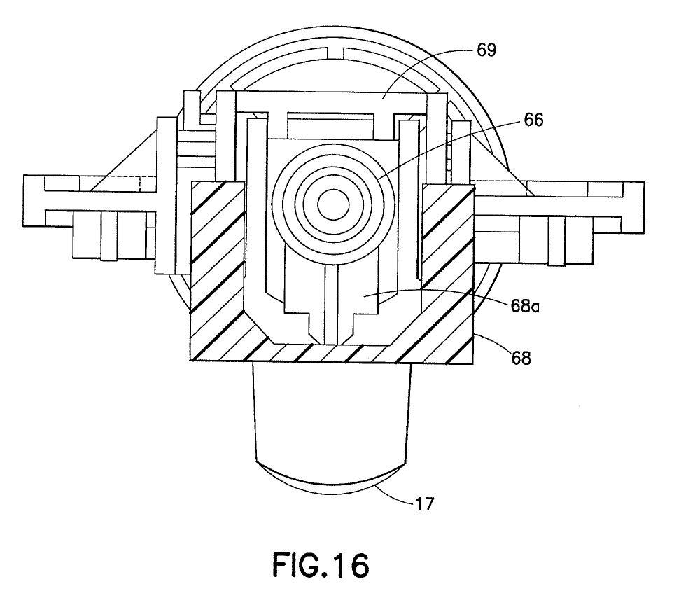

FIG. 16 is a top perspective view of arm 68 of release button 17 that shows how arm 68 controls latch 69 of connector 16.

Steam mop 11 provides many advantages for ease of use because it eliminates the need for an electric water pump and an on/off switch to activate the electric water pump. Here, the user has more control over that amount of water needed to be discharged into the boiler and consequently, how much steam is needed by moving the mop forwards and backwards. In addition, steam mop is designed as a low pressure or non-pressurized system so it is safer for the user to use. Further, since the amount of water is routed to the boiler is controlled, the boiler can create steam is a short amount of time.

Steam mop also provides a water reservoir with windows and a LED light to show the water level of the reservoir. Steam housing easily connects and disconnects to a mop handle and a mop frame while providing a user with universal steering capability. The user has more control of the mop frame by the connection to the mop frame to clean whatever areas that need to be clean and allows use of both sides of steam frame for cleaning. In addition, the mop frame may be rotated so that the user may use both sides of the mop frame to clean. In addition, design of the steam frame may attached to any variety of differently shaped mop frames.

It will thus be seen that the objects set forth above, among those made apparent from the preceding description, are efficiently attained and, since certain changes may be made in the above product without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

The present invention may be embodied in other specific forms without departing from the spirit or essential attributes of the invention. Accordingly, reference should be made to the appended claims, rather than the foregoing specification, as indicating the scope of the invention.

What is claimed is:

1. A steam mop, comprising:
an elongated housing having an outer surface and two ends, the housing containing a water tank having a water inlet and a water outlet, a water pump having a pump inlet connected to the water outlet and a pump outlet, and a boiler connected to the pump outlet;
a mop handle connected to the housing at a first end;
a removable steam frame connected to the housing at a second end; and
the water tank having a water inlet opening to the surface of the housing and having a removable inlet cap and the surface of the housing about the cap indented to form a funnel about the water inlet opening; and
wherein movement of the steam mop activates the pump to pump water from the water tank to the boiler for generation of steam.

2. The steam mop of claim 1, wherein the surface of the housing includes at least one window to allow viewing of the level of water remaining in the water tank.

3. The steam mop of claim 2, including a LED positioned in the tank to improve the viewing of the water tank.

4. The steam mop of claim 1, wherein the mop housing has a bottom opening for connecting to a steam connector to the mop housing for delivering steam to the steam frame.

5. The steam mop of claim 4, including a release button on the housing at the second end, the button having an arm extending across the bottom opening and a hole on the end of the arm;
the connector including a stem for insertion into the bottom opening to engage the steam outlet and having a notch;
the bottom biased outwardly so that the hole is aligned with the axis of the bottom opening and adapted to receive the stem and engage the notch on the stem to hold the connector in place; and
wherein depressing the button release the arm from the notch to allow removal of the stem.

6. A substantially rectangular steam frame assembly comprising:
a front wall having a top and a bottom;
a rear wall having a top and a bottom;
a right side wall; and
a left side wall;
wherein a center baffle extends from the top and bottom of the front wall to the top and bottom of the rear wall to separate a first steam chamber and a second steam chamber;
wherein the rear wall has an opening at the middle of the rear wall for mounting a connector including a top end having a steam inlet for connecting to a steam housing and a bottom end having a pair of steam nozzles for connecting to the steam frame; and
a plurality of baffles alternating at the top of the front wall and the rear wall and at the bottom of the front wall and the rear wall disposed perpendicular to the pair of steam nozzles between the front and rear walls to form a surface for receiving a fabric pocket.

7. A steam mop housing comprising a water tank having a water inlet and a water outlet, a water pump having a pump inlet connected to the water outlet and a pump outlet, and a boiler connected to the pump outlet, wherein the surface of the housing includes at least one window to allow viewing of the level of water remaining in the water tank.

8. The steam mop housing of claim 7, wherein the water tank has a water inlet opening to the surface of the housing and a removable inlet cap and the surface of the housing about the cap indented to form a funnel about the water inlet opening,

9. The steam mop housing of claim 7, including a LED positioned in the water tank to improve the viewing of the water tank.

10. The steam mop housing of claim 7, wherein the mop housing has a bottom opening for connecting to a steam connector to the mop housing for delivering steam to a removable steam frame.

11. The steam mop housing of claim 10, including a release button on the housing about a bottom opening, the button having an arm extending across the bottom opening and a hole on the end of the arm;
the connector including a stem for insertion into the bottom opening to engage the steam outlet and having a notch;
the bottom biased outwardly so that the hole is aligned with the axis of the bottom opening and adapted to receive the stem and engage the notch on the stem to hold the connector in place; and
wherein depressing the button release the arm from the notch to allow removal of the stem.

12. A steam mop, comprising:
an elongated housing having an outer surface and two ends, the housing containing a water tank with a water inlet and a water outlet, a water pump having a pump inlet connected to the water outlet and a pump outlet, and a boiler connected to the pump outlet;
a mop handle connected to the housing at a first end;
a steam outlet and steam frame connection opening at the other end; and
a selectively removable steam frame having a connector releasably engaged with the housing at the second end;
the housing including a release button when depressed releases the engagement of the frame with the housing;
wherein movement of the steam mop activates the pump to pump water from the water tank to the boiler for generation of steam.

13. The steam mop of claim 12, wherein the release button has an arm extending across the steam frame connection opening and a lever intersecting the opening for engaging the connector when inserted and the lever is displaced away from the connector to release the connector when the release button is depressed.

14. The steam mop of claim 12, wherein the surface of the housing includes at least one window to allow viewing of the level of water remaining in the water tank.

15. The steam mop of claim 13, including a LED positioned in the tank to improve the viewing of the water tank.

16. The steam mop of claim 12, wherein the mop housing has a bottom opening for connecting to a steam connector to the mop housing for delivering steam to the steam frame.
